(19) United States
(12) Patent Application Publication
(10) Pub. No.: US 2026/0244808 A1
(43) Pub. Date: Aug. 20, 2026

(54) INTEGRATED PREDICTION METHOD AND SYSTEM FOR VEHICLE POINT CLOUD DRAG COEFFICIENT BASED ON FEATURE RECOGNITION

(71) Applicant: Wuhan University of Technology, Wuhan (CN)

(72) Inventors: Yiping Wang, Wuhan (CN); Mengdi Li, Wuhan (CN); Junyan Wang, Wuhan (CN); Yanru Si, Wuhan (CN); Yuekun Zhang, Wuhan (CN)

(21) Appl. No.: 19/571,480

(22) Filed: Mar. 19, 2026

(30) Foreign Application Priority Data
Jun. 24, 2025 (CN) 2025108466775

(51) Int. Cl. G06F 30/15; G06F 30/27; G06F 111/20

(52) U.S. Cl. CPC G06F 30/15; G06F 30/27; G06F 2111/20

(57) ABSTRACT

An integrated prediction method for vehicle point cloud drag coefficient based on feature recognition includes: acquiring point cloud data of a vehicle model and preprocessing the point cloud data; constructing a classification network model, inputting the preprocessed point cloud data into the classification network model for vehicle type classification, and outputting vehicle type categories and a probability value corresponding to each vehicle type category; constructing a plurality of specialized models corresponding one-to-one to the vehicle type categories and one general model; and determining whether a maximum probability value among the probability values is higher than a preset threshold; if yes, selecting a specialized model corresponding to the vehicle type category associated with the maximum probability value to perform drag coefficient prediction; if no, selecting the general model to perform drag coefficient prediction.

### CROSS-REFERENCE TO RELATED APPLICATIONS

This application claims priority to Chinese patent application No. 202510846677.5, filed on Jun. 24, 2025, which is hereby incorporated by reference in its entirety.

### TECHNICAL FIELD

The present disclosure relates to the field of drag coefficient predicting technology, and in particular to an integrated prediction method and system for vehicle point cloud drag coefficient based on feature recognition.

### BACKGROUND

With the development of the automotive industry, aerodynamic performance, in particular the overall vehicle drag coefficient, has become a crucial indicator for evaluating vehicle performance, improving fuel economy, and reducing emissions.

However, in existing technologies, methods for predicting the drag coefficient are mostly based on traditional Computational Fluid Dynamics (CFD) simulations, wind tunnel experiments, or mathematical modeling. These methods generally suffer from problems such as high computational complexity, long processing time, or reliance on large amounts of experimental data. Especially during the vehicle design process, substantial wind tunnel test data or high-precision CFD calculations are required, making it difficult to optimize vehicle design solutions rapidly and in real-time.

### SUMMARY

The objective of the present disclosure is to provide an integrated prediction method and system for vehicle point cloud drag coefficient based on feature recognition, aiming to solve the problem mentioned in the background art where existing technologies require substantial wind tunnel test data or high-precision CFD calculations, making rapid, real-time optimization of vehicle design solutions difficult.

According to an aspect of some embodiments of the present disclosure there is provided an integrated prediction method for vehicle point cloud drag coefficient based on feature recognition, including: acquiring point cloud data of a vehicle model, and preprocessing the point cloud data; constructing a classification network model, inputting the preprocessed point cloud data into the classification network model for vehicle type classification, and outputting a vehicle type classification label, where the vehicle type classification label includes a plurality of vehicle type categories and a probability value corresponding to each vehicle type category; constructing a drag coefficient prediction model library, where the drag coefficient prediction model library includes a plurality of specialized models respectively corresponding one-to-one to the vehicle type categories and one general model; and determining whether a maximum probability value in the vehicle type classification label is higher than a preset threshold; if yes, selecting a specialized model corresponding to the vehicle type category associated with the maximum probability value to perform drag coefficient prediction; if no, selecting the general model to perform drag coefficient prediction.

In some embodiments, the preprocessing the point cloud data includes: performing normalization processing on the point cloud data; performing augmentation processing on the normalized point cloud data; and performing min-max normalization processing on the augmented point cloud data.

In some embodiments, the constructing the classification network model, inputting the preprocessed point cloud data into the classification network model for vehicle type classification, and outputting the vehicle type classification label specifically includes: constructing a PointNet classification network model, processing the point cloud data through a plurality of multi-layer perceptron (MLP) layers having identical structures; generating a global feature vector through a max pooling layer, and performing feature extraction and classification through a fully connected layer; and outputting each of the vehicle type categories and its corresponding probability value through a softmax layer.

In some embodiments, prior to the step of constructing the PointNet classification network model, the method further includes: constructing a spatial transformer network model to perform global spatial transformation on the point cloud data.

In some embodiments, the vehicle type classification label includes: a sleek-back vehicle type and its corresponding probability value α; a tourer-back vehicle type and its corresponding probability value β; a folded-back vehicle type and its corresponding probability value γ; where 0≤α≤1, 0≤β≤1, and α+β+γ=1.

In some embodiments, the preset threshold is σ, and 0.8≤σ≤1.

In some embodiments, the specialized models are trained using point cloud data corresponding to their respective vehicle type categories, and the general model is trained using point cloud data from all vehicle type categories.

In some embodiments, each model in the drag coefficient prediction model library is based on a dynamic graph convolutional neural network, wherein the dynamic graph convolutional neural network is configured to: utilize a K-Nearest Neighbors (KNN) algorithm to calculate distances between each point in the point cloud data and its nearest neighbor points, and construct an adjacency graph to capture local features of the point cloud data; calculate relative position vectors of each point in the point cloud data through EdgeConv operations, and process the local features using an MLP to transform and update them, thereby extracting global features of the vehicle point cloud; and aggregate the local features and the global features, and output a predicted drag coefficient value through fully connected layers.

In some embodiments, the step of aggregating the local features and the global features includes: aggregating the local features and the global features through at least one of max pooling and average pooling.

According to an aspect of some embodiments of the present disclosure there is provided an integrated prediction system for vehicle point cloud drag coefficient based on feature recognition, including: a preprocessing module, configured to acquire point cloud data of a vehicle model and preprocess the point cloud data; a classification module, configured to construct a classification network model, input the preprocessed point cloud data into the classification network model for vehicle type classification, and output a vehicle type classification label, where the vehicle type classification label includes a plurality of vehicle type categories and a probability value corresponding to each vehicle type category; a prediction module, configured to construct a drag coefficient prediction model library, where the drag coefficient prediction model library includes a plurality of specialized models respectively corresponding one-to-one to the vehicle type categories and one general model; and a matching module, configured to determine whether a maximum probability value in the vehicle type classification label is higher than a preset threshold; if yes, select a specialized model corresponding to the vehicle type category associated with the maximum probability value to perform drag coefficient prediction; if no, select the general model to perform drag coefficient prediction.

### BRIEF DESCRIPTION OF DRAWINGS

The accompanying drawings, which are incorporated in and constitute a part of this specification, illustrate embodiments consistent with the present disclosure and, together with the description, serve to explain the principles of the present disclosure.

To illustrate the embodiments of the present disclosure or the technical solutions in the prior art more clearly, the following briefly introduces the accompanying drawings required for describing the embodiments or the prior art. Obviously, the drawings in the following description show merely some embodiments of the present disclosure. For a person of ordinary skill in the art, other drawings may be derived from these drawings without creative effort.

FIG. 1 is a schematic flowchart of an integrated prediction method for vehicle point cloud drag coefficient based on feature recognition according to according to one or more embodiments of the present disclosure.

FIG. 2 is a schematic diagram of the overall framework of an integrated prediction system for vehicle point cloud drag coefficient based on feature recognition according to one or more embodiments of the present disclosure.

FIG. 3 is a schematic diagram of constructing a specialized model database according to one or more embodiments of the present disclosure.

FIG. 4 is a schematic diagram of a feature recognition workflow based on a PointNet network according to one or more embodiments of the present disclosure.

FIG. 5 is a schematic diagram of a vehicle point cloud drag coefficient prediction model according to one or more embodiments of the present disclosure.

FIG. 6 is a schematic structural diagram of an integrated prediction system for vehicle point cloud drag coefficient based on feature recognition according to one or more embodiments of the present disclosure.

The realization of the objectives, functional features, and advantages of the present disclosure will be further described in conjunction with the embodiments and with reference to the accompanying drawings.

### DETAILED DESCRIPTION OF THE EMBODIMENTS

The following will provide a clear and complete description of the technical solutions of the embodiments of the present disclosure. It is clear that the described embodiments are only part of the embodiments of the present disclosure, not all of them. All other embodiments obtained by those skilled in the art without inventive effort based on the embodiments of the present disclosure fall within the protection scope of the present disclosure.

It should be noted that the terms “first”, “second”, etc. in the description, claims and the above drawings of the present application are used to distinguish similar objects, and are not necessarily used to describe a specific order or sequence. It should be understood that the data so used may be interchanged under appropriate circumstances so that the embodiments of the application described herein can be implemented. In addition, the terms “comprise”, “include”, “contain”, “have” and any variations thereof are intended to cover a non-exclusive inclusion. For example, a process, method, system, product, or device that includes a series of steps or units is not limited to the listed steps or units, but may optionally also include steps or units not listed, or may optionally include other steps or units inherent to such process, method, product, or device.

Those skilled in the art will understand that unless specifically stated, the singular forms “a”, “an” and “the” used herein may also include plural forms. It should be further understood that the term “comprising” as used in the description of the present application means the presence of stated features, integers, steps, operations, elements, and/or components, but does not preclude the presence or addition of one or more other features, integers, steps, operations, elements, components, and/or groups thereof. It should be understood that when an element is referred to as being “connected” or “coupled” to another element, it can be directly connected or coupled to the other element, or intervening elements may be present. In addition, “connected” or “coupled” as used herein may include wireless connection or wireless coupling. The term “and/or” as used herein includes any and all combinations of one or more of the associated listed items.

Those skilled in the art will understand that unless otherwise defined, all terms (including technical and scientific terms) used herein have the same meaning as commonly understood by one of ordinary skill in the art to which this application belongs. It should also be understood that terms such as those defined in commonly used dictionaries should be interpreted as having meanings consistent with their meanings in the context of the prior art and will not be interpreted in an idealized or overly formal sense unless expressly so defined herein.

It should be understood that the sequence numbers and sizes of the steps in the embodiments do not imply an order of execution. The execution order of each process is determined by its function and internal logic and should not constitute any limitation on the implementation process of the embodiments of the present application.

It should be noted that the embodiments in the present application and the features in the embodiments may be combined with each other without conflict. The present application will be described in detail below with reference to the accompanying drawings and embodiments.

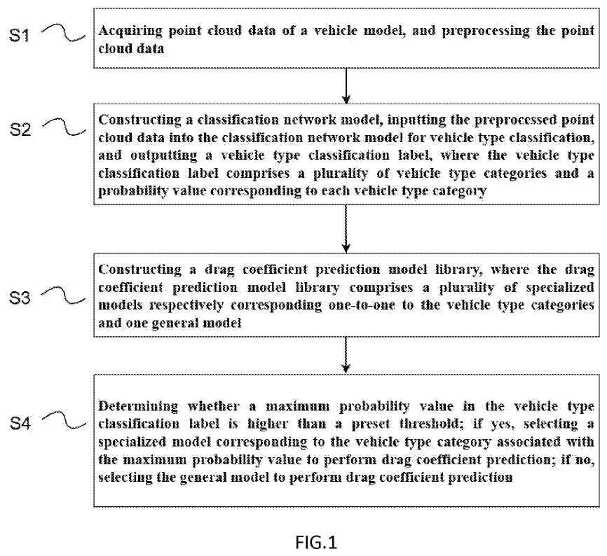

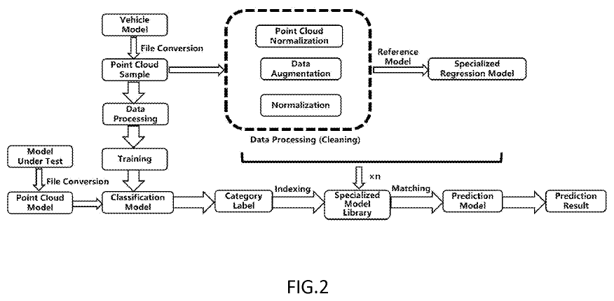

Some embodiments of the present disclosure provide an integrated prediction method for vehicle point cloud drag coefficient based on feature recognition. As shown in FIGS. 1-2, the method includes:

S100: Acquiring point cloud data of a vehicle model, and preprocessing the point cloud data.

Specifically, after starting the program, a vehicle model that has undergone format conversion is input. The vehicle model is converted into point cloud data via file conversion. Each point cloud consists of multiple points, and each point contains spatial coordinates (x, y, z). These points represent the three-dimensional geometric features of the vehicle in space. The preprocessing includes at least one of normalization, augmentation, min-max normalization, and denoising, which may improve data quality and facilitate subsequent network model processing of the point cloud data.

S200: Constructing a classification network model, inputting the preprocessed point cloud data into the classification network model for vehicle type classification, and outputting a vehicle type classification label. The vehicle type classification label includes a plurality of vehicle type categories and a probability value corresponding to each vehicle type category.

Specifically, a classification network model is constructed. The processed point cloud samples are used to train the classification network model. After training, this model is used to accurately identify the vehicle type category of the input point cloud data. The classification network model calculates the probability value corresponding to the vehicle type for the point cloud data through feature extraction and classification algorithms, and this probability value is then used for subsequent matching with drag coefficient prediction models. Point cloud data typically appears as an unordered, sparse three-dimensional point set, with significant geometric feature differences between different vehicle types. These differences are crucial for drag coefficient prediction. By classifying the input point cloud data and categorizing it into the most suitable vehicle type, corresponding specialized prediction model can be selected for subsequent drag coefficient calculation, thereby improving prediction accuracy.

S300: Constructing a drag coefficient prediction model library. The drag coefficient prediction model library includes a plurality of specialized models respectively corresponding one-to-one to the vehicle type categories and one general model.

Specifically, to ensure efficient drag coefficient prediction on different types of point cloud data, the embodiments of present disclosure constructs a drag coefficient prediction model library. This library contains multiple drag coefficient models. In this disclosure, the drag coefficient prediction model library includes a plurality of specialized models and one general model. Specialized models are drag coefficient prediction models obtained by training and testing specifically for one vehicle type. The point cloud data of each vehicle type is used to independently train a specialized model. By training specifically on samples of each category, each model can focus on data of a specific type. These specialized models correspond one-to-one with the vehicle types in the category labels. The general model is a drag coefficient prediction model obtained by training and testing on multiple vehicle types. It can handle data from all vehicle types and learn a more generalized drag coefficient prediction method, thereby improving model robustness and generalization ability. These models work together, selecting the most appropriate model for drag coefficient prediction based on the classification result or generalization determination of the point cloud data.

S400: Determining whether a maximum probability value in the vehicle type classification label is higher than a preset threshold; if yes, selecting a specialized model corresponding to the vehicle type category associated with the maximum probability value to perform drag coefficient prediction; if no, selecting the general model to perform drag coefficient prediction.

Specifically, the classification network model outputs a probability distribution indicating the likelihood that the input point cloud data belongs to each vehicle category. If the maximum probability value is greater than a preset probability threshold, the classification result is used as the type of the point cloud. If the maximum probability value is less than the preset probability threshold, the features of the point cloud data are considered too complex to be clearly classified, and thus it is assigned to the general model for processing.

By classifying the input point cloud data using the classification network model, once the vehicle type is identified, the system selects the corresponding specialized prediction model for drag coefficient calculation, thereby minimizing prediction errors between different vehicle types. Furthermore, if certain input data cannot be classified into a specific vehicle type with high confidence, it is automatically assigned to the general model for prediction, ensuring the applicability and robustness of the system.

It can be understood that the present disclosure first constructs a classification network model, inputs the preprocessed point cloud data into the classification network model for vehicle type classification, and outputs a vehicle type classification label; then, constructs a drag coefficient prediction model library, which includes a plurality of specialized models corresponding one-to-one to the vehicle type categories and a general model; finally, selects either a specialized model or the general model for matching based on the probability value in the classification label, thereby predicting the drag coefficient. By classifying vehicle types and matching them with suitable drag coefficient prediction models, the present disclosure significantly improves prediction speed and the accuracy of prediction results compared to traditional methods that use a unified model for prediction, which require substantial computational resources and suffer from significant calculation errors. The disclosure can be widely applied in drag coefficient evaluation and optimization in automotive design, shortening the development cycle and reducing the research and development costs. Moreover, compared with existing drag coefficient prediction methods, the present disclosure effectively addresses the differences in drag coefficient prediction among different vehicle types by using specialized models trained for different vehicle types, thereby improving prediction accuracy and reliability. The present disclosure fully combines the high accuracy of specialized models with the universality of the general model, not only improving prediction accuracy but also enhancing the adaptability and robustness of the system when facing diverse vehicles. Overall, the present disclosure not only improves the accuracy of drag coefficient prediction but also increases the automation level of the system, better supporting aerodynamic performance optimization in vehicle design.

Referring to FIG. 2, in some embodiments, the preprocessing the point cloud data specifically includes: performing normalization processing on the point cloud data; performing augmentation processing on the normalized point cloud data; performing min-max normalization processing on the augmented point cloud data.

Specifically, the preprocessing improves the quality and robustness of the point cloud data. Point cloud normalization includes: normalizing the point cloud data through rotation, scaling, and translation operations. Data augmentation includes: random sampling, interpolating points, and adding noise points to improve the model's adaptability to different point cloud distributions. Normalization includes: unifying the scale of point cloud data to avoid the impact of scale differences on the classification model.

More specifically, the input point cloud data is a three-dimensional matrix. Assuming the input point cloud has N points, and each point's feature is a 3-dimensional vector (x, y, z). Therefore, the input data is represented as a tensor of shape (N, 3), where N is the number of points and 3 represents the coordinates (x, y, z) of each point. Next, data augmentation techniques are applied, including translation (moving the point cloud by a random factor), adding Gaussian noise (jitter), and randomly dropping some points from the point cloud. These augmentation operations help the model learn more spatial transformations and noise robustness. Finally, the code performs normalization processing on the point cloud data, mapping the coordinate values of each point cloud to the range [0, 1] to facilitate subsequent deep learning training. Specifically, min-max normalization is used to normalize the 3D point cloud data. By traversing each three-dimensional point in the data, max and min values are set for data normalization processing. The calculation formula is as follows:

$${x}^{′} = \frac{x - min ( x )}{max ( x ) - min ( x )} .$$

Where x′ is the value after min-max normalization, x is the original data value, min(x) is the minimum value in the original data, and max(x) is the maximum value in the original data.

A series of standard processing transformations are performed on the image to convert it into a fixed standard form. The entire data processing process ensures the diversity and standardization of point cloud data, providing more representative and generalizable data for model training.

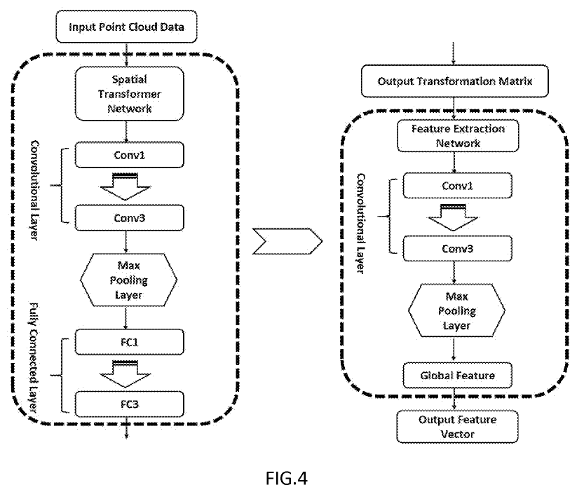

Referring to FIG. 4, in some embodiments, the step of constructing a classification network model, inputting the preprocessed point cloud data into the classification network model for vehicle type classification, and outputting a vehicle type classification label specifically includes: constructing a PointNet classification network model, processing the point cloud data through a plurality of multi-layer perceptron (MLP) layers having identical structures, generating a global feature vector through a max pooling layer, then performing feature extraction and classification through fully connected layers, and finally outputting each of the vehicle type categories and its corresponding probability value through a softmax layer.

Specifically, the present disclosure processes point cloud data, improving the robustness of the network model and ensuring system stability under complex data distributions. Since point cloud data does not have a clear structured order, the PointNet classification network model with several MLP layers of identical structure processes the unordered input point cloud data. During the training of the PointNet classification network, a labeled point cloud dataset is constructed, which includes three-dimensional point cloud samples of sleek-back vehicle type sample data, tourer-back vehicle type sample data, and folded-back vehicle type sample data. A supervised learning method is adopted, and the model is optimized using a cross-entropy loss function. Through multiple rounds of iterative training, the classification model acquires generalization ability for new point cloud data.

Further, the PointNet classification network model extracts local features of each point through several MLP networks of identical structure. The features of each point are processed through MLP to obtain a new feature representation. The calculation formula is as follows:

$$f ( x ) = MLP ( x ) .$$

Where f(x) is the result after processing by the Multi-Layer Perceptron, MLP is a combination of linear transformations and activation functions, and x is the input data.

After each point is processed by MLP, a high-dimensional feature vector is generated, reflecting the local geometric information of that point, which constitutes the local feature. To process each point identically, the PointNet classification network model adopts a weight-sharing strategy, i.e., using the same MLP structure for all points, avoiding the influence of point order on the network.

Next, through the Max Pooling operation, the local features of each point are aggregated into a global feature vector. This operation retains the most significant feature information in the point cloud, ensuring that the network outputs a stable global feature representation even when the point cloud order is unordered. The formula for the max pooling operation is:

$${f}_{global} = max ( {f}_{1} , {f}_{2} , … , {f}_{N} )$$

Where f₁, f₂, . . . , f_{N} are the feature vectors for each of the N points, max is the max pooling operation performed on each feature dimension, and f_{global} is the global feature vector.

The global feature f_{global} is fed into fully connected layers for further processing, ultimately outputting the probability distribution for each category. Specifically, the softmax function converts scores for all categories into a normalized probability distribution, ensuring that the probability for each category is within the range [0,1] and the sum of probabilities for all categories is 1. The category with the highest probability is the network's prediction. If the maximum probability does not exceed 0.8, the data is considered to belong to the general model category.

In some embodiments, prior to the step of constructing the PointNet classification network model, the method further includes: constructing a spatial transformer network model to perform global spatial transformation on the point cloud data.

Specifically, a Spatial Transformer Network STN3d performs global spatial transformation on the entire point cloud data. The spatial transformer network gradually extracts features of the point cloud through three 1D convolutional layers and extracts global features via max pooling. Subsequently, three fully connected layers further process the features and output a 9-dimensional transformation matrix (3×3), which is used to align the point cloud data, allowing the input point cloud data to be processed within the same reference frame.

In some embodiments, the vehicle type classification label includes: a sleek-back vehicle type and its corresponding probability value α; a tourer-back vehicle type and its corresponding probability value β; a folded-back vehicle type and its corresponding probability value γ; where 0≤α≤1, 0≤β≤1, and α+β+γ=1.

It should be understood that to achieve the above objectives, the embodiments of present disclosure adopts the following solution: Different from using a single general model for drag coefficient prediction of multiple vehicle types, the present disclosure classifies input point cloud data based on vehicle shape features and selects the best-matched specialized prediction model for different body designs, thereby improving prediction accuracy.

The present disclosure divides vehicles into three major categories based on differences in roofline and tail structure: sleek-back, tourer-back, and folded-back. These three designs cover the majority of passenger car structures on the market and can effectively represent the aerodynamic characteristics of various sedans and some sports vehicles.

Sleek-back vehicles are characterized by a roofline that slopes smoothly from the windshield to the rear of the car, presenting an overall streamlined shape, such as some sports cars and coupes. Due to the small rear slant angle and delayed airflow separation, the drag coefficient of such vehicles is usually low.

Tourer-back corresponds to station wagons or hatchbacks, with a longer roofline that forms a noticeable downward trend only near the rear to provide more trunk space. Because the rear is relatively vertical, airflow separation zones are easily formed, resulting in drag characteristics different from sleek-back or folded-back vehicles.

Folded-back refers to traditional sedans with a clear three-box structure, where the trunk forms a distinct angle with the rear windshield, causing the rear airflow pattern to differ significantly from fastback and estate vehicles, typically forming strong vortex structures in the trunk area.

Specifically, point cloud data is classified into three categories: sleek-back, tourer-back, and folded-back vehicle types. The entire system is highly adaptable and supports expansion to multiple vehicle types. Models for each category are trained based on the geometric features of different vehicle types to better capture these features and improve prediction accuracy. The classification module outputs a probability distribution indicating the likelihood that the input point cloud data belongs to each category. The Softmax function converts scores for all categories into a normalized probability distribution, ensuring that the probability for each category is within the range [0,1] and the sum of probabilities for all categories is 1.

In some embodiments, the preset threshold is σ, and 0.8≤σ≤1.

Specifically, setting the preset threshold to σ, and 0.8≤σ≤1, ensures the accuracy of the classification model, thereby reducing the computational resources and time required for the drag coefficient prediction model and improving the accuracy of drag coefficient prediction. If the threshold is too low, it may affect the accuracy of specialized models. Exemplarily, the present disclosure presets the threshold to 0.8. The classification module outputs a probability distribution indicating the likelihood that the input point cloud data belongs to each category. If the maximum probability value is greater than 0.8, the classification result is used as the type of the point cloud. If the maximum probability value is less than 0.8, the features of the point cloud data are considered too complex to be clearly classified, and thus it is assigned to the general model for processing.

It can be understood that by introducing the threshold of 0.8, a balance between classification accuracy and generalization ability is achieved: when the classification result is relatively clear, the system utilizes specialized models to improve prediction accuracy; when classification confidence is low, the system uses the general model to ensure prediction stability. This mechanism effectively avoids the impact of classification errors on drag coefficient prediction accuracy while ensuring the system can handle a wider range of vehicle designs, giving it higher reliability and applicability in practical applications. By classifying point cloud data and matching specialized regression models for drag coefficient prediction based on the characteristics of different vehicle types, the problem of poor generalization ability of traditional single models and insufficient prediction accuracy of general models is solved.

Specifically, if the highest category probability of the point cloud data is greater than the threshold of 0.8, the classification result is considered reliable, and the specialized model corresponding to that category is directly used for drag coefficient prediction. Specialized models are trained for the geometric features of that category, enabling more accurate capture of the aerodynamic characteristics of that vehicle type, thereby reducing prediction errors and improving accuracy. However, in practical applications, some vehicle shapes may fall between different categories. For example, some vehicles with special roof designs may have geometric features of both sleek-back and tourer-back types. In such cases, the classification network may have difficulty making a clear judgment, resulting in probabilities for all categories being relatively close, with no category exceeding a confidence level of 0.8. If the maximum category probability is below 0.8, the features of the point cloud data are considered too complex or ambiguous to be accurately classified. In this case, the system automatically assigns it to the general model for processing. The general model has strong adaptability and can predict point cloud data that is not clearly classified, ensuring the robustness and applicability of the entire system.

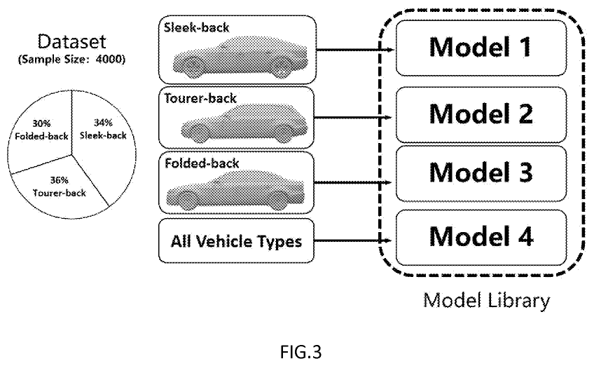

Referring to FIG. 3, in some embodiments, the specialized models are trained using point cloud data corresponding to their respective vehicle type categories, and the general model is trained using point cloud data from all vehicle type categories.

Specifically, sample data division involves randomly dividing the data samples of each category, with 80% of the data used for training and 20% for testing. Using the sample data of sleek-back, tourer-back, and folded-back vehicle types respectively, Model1, Model2, and Model3 are trained, resulting in three specialized models. In addition to specialized models, a general model is needed to handle point cloud data that cannot be clearly classified. When the classification module determines that the maximum classification probability of the point cloud data is less than 0.8, the data is sent to the general model. To train the general model Model4, all data samples (sleek-back, tourer-back, folded-back) are combined and randomly divided into 80% training data and 20% testing data. Thus, Model4 can handle data from all three vehicle types and learn a more generalized drag coefficient prediction method, improving model robustness and generalization ability. Finally, the model library will contain four models: Model1, Model2, Model3, and Model4, of which three are specialized models and one is a general model. These models work together, selecting the most appropriate model for drag coefficient prediction based on the classification result or generalization determination of the point cloud data. Moreover, the system uses feature recognition and can dynamically expand the specialized model library according to newly added vehicle categories, possessing good adaptability and scalability.

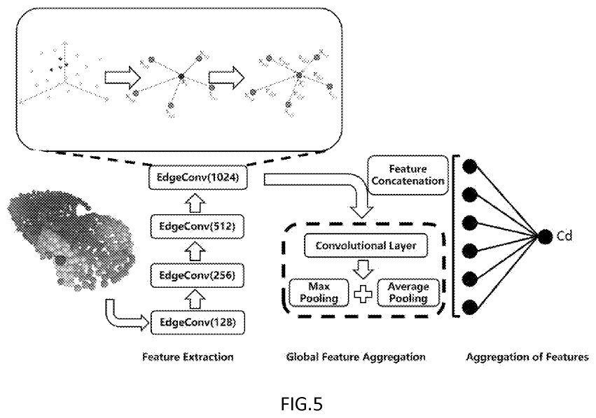

Referring to FIG. 5, in some embodiments, each model in the drag coefficient prediction model library is based on a dynamic graph convolutional neural network, wherein the dynamic graph convolutional neural network is configured to: utilize a K-Nearest Neighbors (KNN) algorithm to calculate distances between each point in the point cloud data and its nearest neighbor points, and construct an adjacency graph to capture local features of the point cloud data; calculate relative position vectors of each point in the point cloud data through EdgeConv operations, and process the local features using an MLP to transform and update them, thereby extracting global features of the vehicle point cloud; and aggregate the local features and the global features, and output a predicted drag coefficient value through fully connected layers.

Specifically, after classification is completed, the point cloud data is further fed into the corresponding specialized model in the model library for processing. These specialized models employ Graph Convolutional Neural Network methods to extract local and global features from the point cloud data. In the graph convolutional network, the KNN algorithm is first used to find the k nearest neighbors for each point. This process first involves calculating distances between points, typically using Euclidean distance as the metric. Let the feature of each point be Xᵢ=(i=1,2, . . . , N), where N is the number of points in the point cloud, and the point's features may be its spatial coordinates or other additional descriptive information. The formula for Euclidean distance is as follows:

$$d ( {x}_{i} , {x}_{j} ) = \sqrt{{\sum }_{m = 1}^{n} {( {x}_{i}^{( m )} - {x}_{j}^{( m )} )}^{2}} .$$

Where d(xᵢ,xⱼ) is the Euclidean distance between points

$${x}_{i} = ( {x}_{i}^{( 1 )} , {x}_{i}^{( 2 )} , … , {x}_{i}^{( n )} ) and {x}_{j} = ( {x}_{j}^{( 1 )} , {x}_{j}^{( 2 )} , … , {x}_{j}^{( n )} ) ,$$

commonly used for neighbor search in point cloud data. For each pair of points, the model calculates the pairwise Euclidean distance through matrix multiplication combined with the squared sum of points.

Specifically, assuming E∈ R^{N×D} is the matrix of the point cloud data, where N is the number of points, and D is the dimension of each point (e.g., 3D coordinates), the pairwise distance matrix is calculated as follows:

$${D}_{ij} = - 2 {X}_{i}^{T} {X}_{j} + {‖ {X}_{i} ‖}^{2} + {‖ {X}_{j} ‖}^{2} .$$

Where Dᵢⱼ is the squared Euclidean distance between points i and j, and Xᵢ and Xⱼ are the feature vectors of points i and j, respectively.

For the calculated distance matrix, we need to find the k nearest neighbors for each point:

$${Idx}_{i , :} = arg {min}_{{S ∈ \{ 1 , 2 , … , N \}}_{S = k , i ∈ S}} {\sum }_{j ∈ S} d ( {x}_{i} , {x}_{j} )$$

Where Idx ∈ R^{NXk}, Idx_{i,}:stores the indices of the k-nearest neighbors for point i, and the constraint ensures that the point itself is not selected. This optimization objective ensures that the chosen k points are those with the smallest distances. This method calculates the pairwise distances for all points and selects the k nearest neighbors for each point from the distance matrix, thereby obtaining the neighbor indices idx ∈ R^{N×D}.

Once the k nearest neighbors for each point are found, the next step is to calculate relative position vectors and construct a graph feature matrix. The relative position vector rᵢⱼ of a point refers to the offset of point xⱼ relative to point xᵢ,which is calculated as follows:

$${r}_{ij} = {x}_{j} - {x}_{i} .$$

Where rᵢⱼ is the relative position vector of the point, xᵢ is the i-th point, and xⱼ is the j-th point.

In this way, the relative position features between each point and its neighbors are extracted. The graph feature matrix G is formed by concatenating each point's own features with the relative position features to its k neighbors. Assuming the feature dimension of each point is D, the shape of the graph feature matrix for each point and its neighbors is N×k×(2D), where 2D includes the point's own feature and the relative positions to its neighbor points.

Graph Convolution (GCN) is a convolution operation based on graph-structured data, extracting local and global features by aggregating neighbor node information. Here, EdgeConv operation is used to update each point's features through its neighbors' information. Each layer of graph convolution uses relative position vectors and original point features to perform convolution.

Specifically, the EdgeConv operation may be expressed as:

First, the k-nearest neighbors of each point are identified via the aforementioned KNN algorithm, and a local adjacency relationship is established. For each point i and its neighbor j, the relative position vector rᵢⱼ=xⱼ−xᵢ is calculated.

Subsequently, a density weighting mechanism is introduced. By combining the point's own feature xᵢ, an edge feature is constructed as follows:

$$\begin{matrix}H ( {x}_{i} , {x}_{j} ) = \frac{1}{d ( {x}_{i} , {x}_{j} )} H ( {x}_{i} , {x}_{j} - {x}_{i} ) . \\ \frac{1}{d ( {x}_{i} , {x}_{j} )}\end{matrix}$$

is the density weighting coefficient, and d(xᵢ,xⱼ) is the Euclidean distance between point i and point j. Using the Euclidean distance calculated by KNN as the weighting factor helps reduce computational waste. Introducing the density weighting coefficient enhances the model's focus on edge-sensitive parts such as side mirrors, door handles, and wheels.

Use MLP for feature transformation:

$$H ( {x}_{i} , {x}_{j} ) = MLP ( {\sum }_{j ∈ N ( i )} φ ( {x}_{i} , {x}_{j} ) )$$

Where H(xᵢ,xⱼ) a is the convolved feature for point i, N(i) is the neighbor set of point i, and φ(xᵢ,xⱼ) is a feature transformation function based on the features of point i and its neighbor point j, which is typically implemented by a MLP. In each convolutional layer, through multiple EdgeConv operations, local geometric information is continuously combined with global information, extracting more abstract and richer features. After the convolutional layers, to enhance the expression of global information, the model employs pooling operations. Common pooling operations include Max Pooling and Average Pooling. Through pooling, the model can aggregate features at a global level, obtaining a more comprehensive representation.

The features after max pooling and average pooling are fed into multiple fully connected layers for processing. By gradually reducing feature dimensions, the model's output is eventually obtained. In regression tasks, the final output is typically a scalar, such as the predicted drag coefficient value. Through end-to-end training, the model continuously optimizes parameters during the training process, making the final prediction result as close as possible to the true value.

For regression tasks, the network's final output is the drag coefficient, a scalar. The network optimizes the output through a regression loss function, such as Mean Squared Error (MSE), eventually obtaining the best prediction result through training.

Specifically, the regression loss function may be expressed as:

$${L}_{reg} = \frac{q}{N} {\sum }_{i = 1}^{N} {( {\overline{y}}_{i} - {y}_{i} )}^{2} .$$

Where y̅ᵢ is the predicted value for the i-th sample, yᵢ is the true value, and N is the number of samples.

Overall, after PointNet network classification, graph convolution operations are combined for drag coefficient prediction from point cloud data. By calculating each point's nearest neighbors via the KNN algorithm and extracting local and global features through graph convolution operations, the model gradually learns the spatial structure of the point cloud and finally outputs the prediction result through the regression layer. This method can effectively capture the geometric features of point cloud data when processing it, providing accurate predictions for regression tasks.

It can be understood that the prediction model is based on Dynamic Graph Convolutional Neural Network (DGCNN/EdgeConv). It first uses the KNN algorithm to calculate distances between input point cloud data and its nearest neighbor points, further constructing an adjacency graph. Then, through graph edge convolution operations, information between adjacent points is propagated, updating the feature representation of each point. Dynamic graph edge convolution layers can effectively learn the local geometric structure of point cloud data, enabling the model to better capture relationships between different points in the point cloud. Next, max pooling and average pooling operations are used to aggregate features. These pooling operations help the model extract global information and, to some extent, reduce data dimensionality, improving computational efficiency and stability. Max pooling typically retains the most significant features in the input data, while average pooling helps capture overall features. Finally, through fully connected layers, the pooled features are processed, and the final drag coefficient prediction value is generated. The fully connected layers learn the global features of the point cloud data, fuse multi-level information, and output a regression value, which is the predicted drag coefficient. The entire process is trained through backpropagation and gradient descent optimization algorithms to minimize the error between predicted values and true drag coefficients.

In some embodiments, the step of aggregating the local features and the global features includes: aggregating the local features and the global features through at least one of max pooling and average pooling.

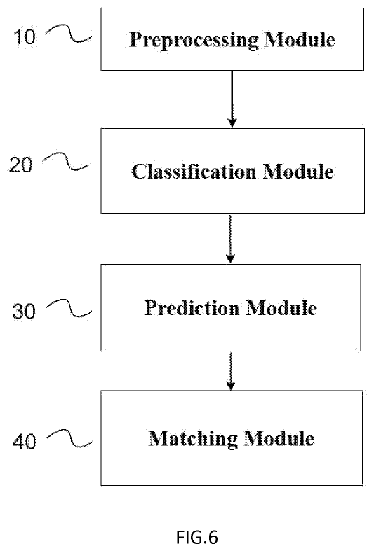

Referring to FIG. 6, on the other hand, the present disclosure also provides an integrated prediction system for vehicle point cloud drag coefficient based on feature recognition, including: a preprocessing module 10, configured to acquire point cloud data of a vehicle model and preprocess the point cloud data; a classification module 20, configured to construct a classification network model, input the preprocessed point cloud data into the classification network model for vehicle type classification, and output a vehicle type classification label, wherein the vehicle type classification label includes a plurality of vehicle type categories and a probability value corresponding to each vehicle type category; a prediction module 30, configured to construct a drag coefficient prediction model library, wherein the drag coefficient prediction model library includes a plurality of specialized models respectively corresponding one-to-one to the vehicle type categories and one general model; a matching module 40, configured to determine whether a maximum probability value in the vehicle type classification label is higher than a preset threshold; if yes, select a specialized model corresponding to the vehicle type category associated with the maximum probability value to perform drag coefficient prediction; if no, select the general model to perform drag coefficient prediction.

In the embodiments of present disclosure, among the 4000 data samples used, 34% are sleek-back vehicle data samples, 36% are tourer-back vehicle data samples, and 30% are folded-back vehicle data samples. During the construction of the model library, first, the data of each category is randomly divided into 80% training data and 20% testing data. The sample data of sleek-back, tourer-back, and folded-back types are used to train Model1, Model2, and Model3, respectively. Then, all 4000 data samples are also randomly divided into 80% training data and 20% testing data to train the general model Model4. The model library contains Model1, Model2, Model3, and Model4, totaling three specialized models and one general model.

Further, when a point cloud data is input, the Spatial Transformer Network STN3d performs global spatial transformation on the entire point cloud data. The spatial transformer network gradually extracts features of the point cloud through three 1D convolutional layers and extracts global features via max pooling. Subsequently, three fully connected layers further process the features and output a 9-dimensional transformation matrix (3×3), which is used to align the point cloud data, allowing the input point cloud data to be processed within the same reference frame. The point cloud data processed by the transformation matrix then enters the PointNet encoder. First, local features are extracted through a convolutional layer (conv1, conv2, conv3), then global features are extracted through max pooling, and finally a feature vector is output. For each input point cloud data, the PointNet network outputs a feature vector representing the probability distribution of the data belonging to each category. The category with the highest probability is the network's classification result. If the maximum probability does not exceed 0.8, the data is classified into the general model category.

Further, after being classified by the PointNet network, the point cloud data is input into the corresponding model in the model library for further processing. First, the model calculates the k (k=20 in the figure) nearest neighbors for each point using the KNN algorithm. To find the nearest neighbors for each point, the model calculates pairwise distances between points through transpose and matrix multiplication.

Specifically, the Euclidean distance between each pair of points is calculated via inner product and the squared sum of points, ultimately obtaining a pairwise distance matrix. Based on this distance matrix, the model selects the k points with the smallest distances and returns the indices of the k nearest neighbors for each point. Subsequently, using these found nearest neighbors, the model calculates relative position vectors and constructs a graph feature matrix, forming local graph features. Next, the graph convolution EdgeConv operation extracts local and global features through multiple convolutional layers, continuously learning the spatial structure of the point cloud. In each convolutional layer, the original point features and the relative position features of neighbor points are used together to compute the convolution. In this way, the network can effectively capture the geometric features of the point cloud data and gradually refine higher-order features across multiple convolutional layers. After the graph convolutional layers, the model employs max pooling and average pooling to globally aggregate features from each layer, further enhancing the expression of global information. Subsequently, these features are processed through multiple fully connected layers, gradually reducing feature dimensions, and finally, the prediction result is output through the regression layer. In regression tasks, the final output is typically a scalar, such as the predicted drag coefficient value. The entire model is trained end-to-end, optimizing network parameters so that given point cloud data, it can accurately predict the target value.

If the integrated units are implemented in the form of software functional units and sold or used as independent products, they can be stored in a computer-readable storage medium. Based on this understanding, the technical solution of the present disclosure, in essence, or the part contributing to the prior art, or all or part of the technical solution, can be embodied in the form of a software product. The computer software product is stored in a storage medium and includes several instructions for causing a computer device which may be a personal computer, server, or network device to perform all or part of the steps of the methods described in the embodiments of the present disclosure. The aforementioned storage medium includes: U disk, mobile hard disk, read-only memory (ROM), random access memory (RAM), magnetic disk, optical disk, or other media that can store program code.

Those of ordinary skill in the art will understand that all or part of the processes in the methods of the above embodiments can be implemented by a computer program instructing relevant hardware. The computer program can be stored in a non-volatile computer-readable storage medium. When executed, the computer program can include the processes of the embodiments of the above methods. Any reference to memory, storage, database, or other media used in the embodiments provided herein may include non-volatile and/or volatile memory. Non-volatile memory may include read-only memory (ROM), programmable ROM (PROM), electrically programmable ROM (EPROM), electrically erasable programmable ROM (EEPROM), or flash memory. Volatile memory may include random access memory (RAM) or external cache memory. By way of illustration and not limitation, RAM is available in many forms, such as static RAM (SRAM), dynamic RAM (DRAM), synchronous DRAM (SDRAM), double data rate SDRAM (DDRSDRAM), enhanced SDRAM (ESDRAM), SynchLink DRAM (SLDRAM), Rambus direct RAM (RDRAM), direct Rambus dynamic RAM (DRDRAM), and Rambus dynamic RAM (RDRAM).

The above descriptions are only part of the embodiments of the present disclosure and are not intended to limit the patent scope of the present disclosure. Any equivalent structural transformations made using the technical concept of the present disclosure, directly or indirectly applied in other related technical fields, are included within the patent protection scope of the present disclosure.

What is claimed is:

1. An integrated prediction method for vehicle point cloud drag coefficient based on feature recognition, comprising:
acquiring point cloud data of a vehicle model, and preprocessing the point cloud data;
constructing a classification network model, inputting the preprocessed point cloud data into the classification network model for vehicle type classification, and outputting a vehicle type classification label, wherein the vehicle type classification label comprises a plurality of vehicle type categories and a probability value corresponding to each vehicle type category;
constructing a drag coefficient prediction model library, wherein the drag coefficient prediction model library comprises a plurality of specialized models respectively corresponding one-to-one to the vehicle type categories and one general model; and
determining whether a maximum probability value in the vehicle type classification label is higher than a preset threshold; if yes, selecting a specialized model corresponding to the vehicle type category associated with the maximum probability value to perform drag coefficient prediction; if no, selecting the general model to perform drag coefficient prediction.

2. The method of claim 1, wherein the preprocessing the point cloud data comprises:
performing normalization processing on the point cloud data;
performing augmentation processing on the normalized point cloud data; and
performing min-max normalization processing on the augmented point cloud data.

3. The method of claim 1, wherein the constructing the classification network model, inputting the preprocessed point cloud data into the classification network model for vehicle type classification, and outputting the vehicle type classification label specifically comprises:
constructing a PointNet classification network model, processing the point cloud data through a plurality of multi-layer perceptron (MLP) layers having identical structures;
generating a global feature vector through a max pooling layer, and performing feature extraction and classification through a fully connected layer; and
outputting each of the vehicle type categories and its corresponding probability value through a softmax layer.

4. The method of claim 3, wherein prior to the step of constructing the PointNet classification network model, the method further comprises:
constructing a spatial transformer network model to perform global spatial transformation on the point cloud data.

5. The method of claim 1, wherein the vehicle type classification label comprises:
a sleek-back vehicle type and its corresponding probability value α;
a tourer-back vehicle type and its corresponding probability value β;
a folded-back vehicle type and its corresponding probability value γ;
wherein 0≤α≤1, 0≤β≤1, 0≤γ≤1, and α+β+γ=1.

6. The method of claim 1, wherein the preset threshold is σ, and 0.8≤σ≤1.

7. The method of claim 1, wherein the specialized models are trained using point cloud data corresponding to their respective vehicle type categories, and the general model is trained using point cloud data from all vehicle type categories.

8. The method of claim 1, wherein each model in the drag coefficient prediction model library is based on a dynamic graph convolutional neural network, wherein the dynamic graph convolutional neural network is configured to:
utilize a K-Nearest Neighbors (KNN) algorithm to calculate distances between each point in the point cloud data and its nearest neighbor points, and construct an adjacency graph to capture local features of the point cloud data;
calculate relative position vectors of each point in the point cloud data through EdgeConv operations, and process the local features using an MLP to transform and update them, thereby extracting global features of the vehicle point cloud; and
aggregate the local features and the global features, and output a predicted drag coefficient value through fully connected layers.

9. The method of claim 8, wherein the step of aggregating the local features and the global features comprises:
aggregating the local features and the global features through at least one of max pooling and average pooling.

10. An integrated prediction system for vehicle point cloud drag coefficient based on feature recognition, comprising:
a preprocessing module, configured to acquire point cloud data of a vehicle model and preprocess the point cloud data;
a classification module, configured to construct a classification network model, input the preprocessed point cloud data into the classification network model for vehicle type classification, and output a vehicle type classification label, wherein the vehicle type classification label comprises a plurality of vehicle type categories and a probability value corresponding to each vehicle type category;
a prediction module, configured to construct a drag coefficient prediction model library, wherein the drag coefficient prediction model library comprises a plurality of specialized models respectively corresponding one-to-one to the vehicle type categories and one general model; and
a matching module, configured to determine whether a maximum probability value in the vehicle type classification label is higher than a preset threshold; if yes, select a specialized model corresponding to the vehicle type category associated with the maximum probability value to perform drag coefficient prediction; if no, select the general model to perform drag coefficient prediction.
